(19) United States
(12) Patent Application Publication
(10) Pub. No.: US 2021/0185299 A1
(43) Pub. Date: Jun. 17, 2021

(54) A MULTI-CAMERA DEVICE AND A CALIBRATION METHOD

(71) Applicant: Nokia Technologies Oy, Espoo (FI)

(72) Inventors: Adrian Burian, Tampere (FI); Andrew Baldwin, Tampere (FI); Kim Gronholm, Helsinki (FI)

(21) Appl. No.: 16/078,793

(22) PCT Filed: Feb. 23, 2017
(86) PCT No.: PCT/FI2017/050120

§ 371 Date: Aug. 22, 2018

(30) Foreign Application Priority Data
Feb. 26, 2016 (GB) 1603350.8

(51) Int. Cl. H04N 13/257; H04N 13/15; H04N 13/296; H04N 17/02; H04N 13/246

(52) U.S. Cl. CPC H04N 13/257; H04N 13/15; H04N 2013/0077; H04N 17/02; H04N 13/246; H04N 13/296

(57) ABSTRACT

The invention relates to a method for calibrating color components of the sensors of a multi-camera device. The method comprises capturing images by more than one sensor of a multi-camera device (910); creating a pool of images of the captured images (920); extracting a first set of color correction parameters utilizing the pool of images (930); extracting a second set of color correction parameters utilizing the pool of images, wherein the second set of color correction parameters has the smallest errors relative to the first set of color correction parameters (940); and calibrating color components of said more than one sensors of the multi-camera device according to the second set of color correction parameters (950).

### BACKGROUND

Digital stereo viewing or still and moving images has become commonplace, and equipment for viewing 3D (three-dimensional) movies is more widely available. Theatres are offering 3D movies based on viewing the movie with special glasses that ensure the viewing of different images for the left and right eye for each frame of the movie. The same approach has been brought to home use with 3D-capable players and television sets. In practice, the movie consists of two views to the same scene, one for the left eye and one for the right eye. These views have been created by capturing the movie with a special stereo camera that directly creates this content suitable for stereo viewing. When the views are presented to the two eyes, the human visual system creates a 3D view of the scene. In this technology the viewing area (movie screen or television) only occupies part of the field of vision, and thus the experience of 3D view is limited.

For a more realistic experience, devices occupying a larger viewing area or the total field of view have been created. There are available special stereo viewing goggles that are meant to be worn on the head so that they cover the eyes and display picture for the left and right eye with a small screen and lens arrangement. Such technology has also the advantage that it can be used in a small space, and even while on the move, compared to fairly large TV sets commonly used for 3D viewing.

### SUMMARY

Now there has been invented an improved method and technical equipment implementing the method, for an improved viewer experience of 3D content. Various aspects of the invention include a method, an apparatus and a computer readable medium comprising a computer program stored therein, which are characterized by what is stated in the independent claims. Various embodiments of the invention are disclosed in the dependent claims.

According to a first aspect, there is provided a method, comprising: capturing images by more than one sensor of a multi-camera device; creating a pool of images of the captured images; extracting a first set of color correction parameters utilizing the pool of images; extracting a second set of color correction parameters utilizing the pool of images, wherein the second set of color correction parameters has the smallest error relative to the first set of color correction parameters; calibrating color components of said more than one sensors of the multi-camera device according to the second set of color correction parameters.

According to an embodiment of the first aspect, the images are captured in different color temperatures and capturing conditions, wherein the pool of images comprises images in different color temperatures and capturing conditions.

According to an embodiment of the first aspect or of the previous embodiment, the method further comprises detecting one or more target color patterns from the images of the pool of images, and defining the first set of color correction parameters to be those that give the smallest color error relative to the color target pattern.

According to an embodiment of the first aspect or any of the previous embodiments, two or more of the images are captured simultaneously.

According to an embodiment of the first aspect or any of the previous embodiments, two or more of the images are captured at different times.

According to a second aspect, there is provided an apparatus comprising at least one processor, memory including computer program code, the memory and the computer program code configured to, with the at least one processor, cause the apparatus to perform at least the following: capture images by more than one sensor of a multi-camera device; create a pool of images of the captured images; extract a first set of color correction parameters utilizing the pool of images; extract a second set of color correction parameters utilizing the pool of images, wherein the second set of color correction parameters has the smallest error relative to the first set of color correction parameters; and calibrate color components of said more than one sensors of the multi-camera device according to the second set of color correction parameters.

According to an embodiment of the second aspect, the images are captured in different color temperatures and capturing conditions, wherein the pool of images comprises images in different color temperatures and capturing conditions.

According to an embodiment of the second aspect or of the previous embodiment, the apparatus further comprises computer program code to cause the apparatus to detect one or more target color patterns from the images of the pool of images, and to define the first set of color correction parameters to be those that give the smallest color error relative to the color target pattern.

According to an embodiment of the second aspect or any of the previous embodiments, two or more of the images are captured simultaneously.

According to an embodiment of the second aspect or any of the previous embodiments, two or more of the images are captured at different times.

According to a third aspect, there is provided an apparatus comprising at least processing means and memory means including computer program code, wherein the apparatus further comprises more than one sensors for capturing images; means for creating a pool of images of the captured images; means for extracting a first set of color correction parameters utilizing the pool of images; means for extracting a second set of color correction parameters utilizing the pool of images, wherein the second set of color correction parameters has the smallest error relative to the first set of color correction parameters; and means for calibrating color components of said more than one sensors of the multi-camera device according to the second set of color correction parameters.

According to a fourth aspect, there is provided a computer program product embodied on a non-transitory computer readable medium, comprising computer program code configured to, when executed on at least one processor, cause an apparatus or a system to: capture images by more than one sensor of a multi-camera device; create a pool of images of the captured images; extract a first set of color correction parameters utilizing the pool of images; extract a second set of color correction parameters utilizing the pool of images, wherein the second set of color correction parameters has the smallest error relative to the first set of color correction parameters; and calibrate color components of said more than one sensors of the multi-camera device according to the second set of color correction parameters.

### DESCRIPTION OF THE DRAWINGS

In the following, various embodiments of the invention will be described in more detail with reference to the appended drawings, in which

In the following, various embodiments of the invention will be described in more detail with reference to the appended drawings, in which

FIGS. 1a, 1b, 1c and 1d show a setup for forming a stereo image to a user;

FIG. 2a shows a system and apparatuses for stereo viewing;

FIG. 2b shows a stereo camera device for stereo viewing;

FIG. 2c shows a head-mounted display for stereo viewing;

FIG. 2d illustrates a camera;

FIGS. 3a and 3b illustrate forming stereo images for first and second eye from image sources;

FIGS. 4a and 4b show an example of a camera device for being used as an image source;

FIGS. 5a-5d show the use of source (s) and destination (d) coordinate systems for stereo viewing;

FIGS. 6a, 6b, 6c, 6d, 6e, 6f, 6g and 6h show exemplary camera devices for stereo image capture;

FIGS. 7a and 7b illustrate transmission of image source data for stereo viewing;

FIG. 8 shows a flowchart of a method for stereo viewing; and

FIG. 9 shows a flowchart of a method according to an embodiment.

### DESCRIPTION OF EXAMPLE EMBODIMENTS

The present description relates to an improved image processing method in a multi-camera device. The multi-camera device has a view direction and comprises a plurality of cameras, at least one central camera and at least two peripheral cameras. Each said camera has a respective field of view, and each said field of view covers the view direction of the multi-camera device. The cameras are positioned with respect to each other such that the central cameras and peripheral cameras form at least two stereo camera pairs with a natural disparity and a stereo field of view, each said stereo field of view covering the view direction of the multi-camera device. The multi-camera device has a central field of view, the central field of view comprising a combined stereo field of view of the stereo camera pairs, and a peripheral field of view comprising fields of view of the cameras at least partly outside the central field of view.

The multi-camera device may comprise cameras at locations essentially corresponding to at least some of the eye positions of a human head at normal anatomical posture, eye positions of the human head at maximum flexion anatomical posture, eye positions of the human head at maximum extension anatomical posture, and/or eye positions of the human head at maximum left and right rotation anatomical postures. The multi-camera device may comprise at least three cameras, the cameras being disposed such that their optical axes in the direction of the respective camera's field of view fall within a hemispheric field of view, the multi-camera device comprising no cameras having their optical axes outside the hemispheric field of view, and the multi-camera device having a total field of view covering a full sphere.

The multi-camera device may comprise depth estimation sensors aligned with the cameras. This is to accurately report the scene depth in any required embodiment.

The descriptions above may describe the same multi-camera device or different multi-camera devices. Such multi-camera devices may have the property that they have cameras disposed in the direction of view of the camera device, that is, their field of view is not symmetric, e.g. Not covering a full sphere with equal quality or equal number of cameras. This may bring the advantage that more cameras can be used to capture the visually important area in the view direction and around it (the central field of view), while covering the rest with lesser quality, e.g. without stereo image capability. At the same time, such asymmetric placement of cameras may leave room in the back of the device for electronics and mechanical structures.

The multi-camera devices described here may have cameras with wide-angle lenses. The multi-camera device may be suitable for creating stereo viewing image data, comprising a plurality of video sequences for the plurality of cameras. The multi-camera device may be such that any pair of cameras of the at least three cameras has a parallax corresponding to parallax (disparity) of human eyes for creating a stereo image. At least three cameras may overlapping fields of view such that an overlap region for which every part is captured by said at least three cameras is defined, and such overlap area can be used in forming the image for stereo viewing.

In the following, several embodiments of the invention will be described in the context of stereo viewing with 3D glasses. It is to be noted, however, that the invention is not limited to any specific display technology. In fact, the different embodiments have applications in any environment where stereo viewing is required, for example movies and television. Additionally, while the description uses a certain camera setups as examples, different camera setups can be used, as well.

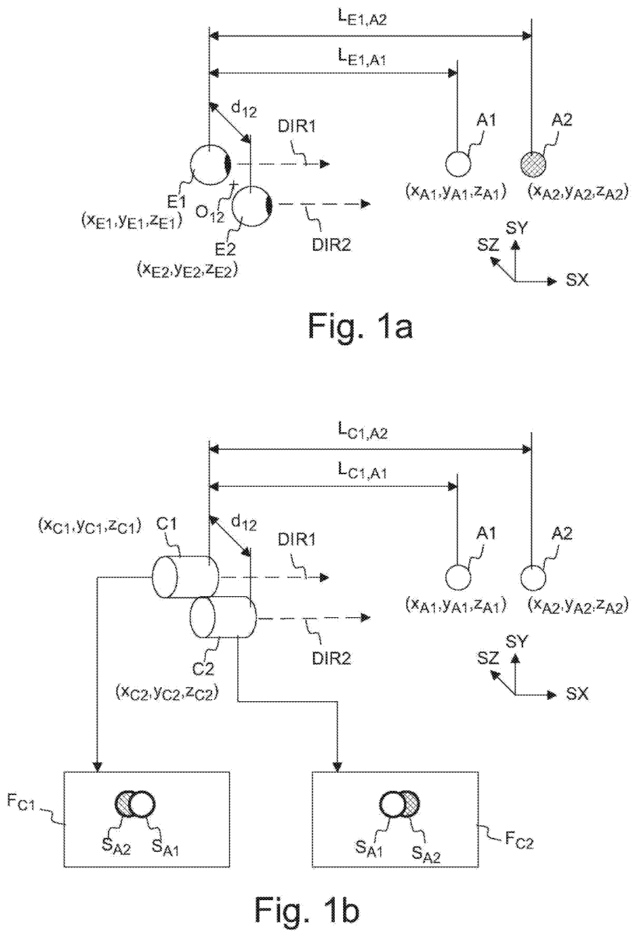

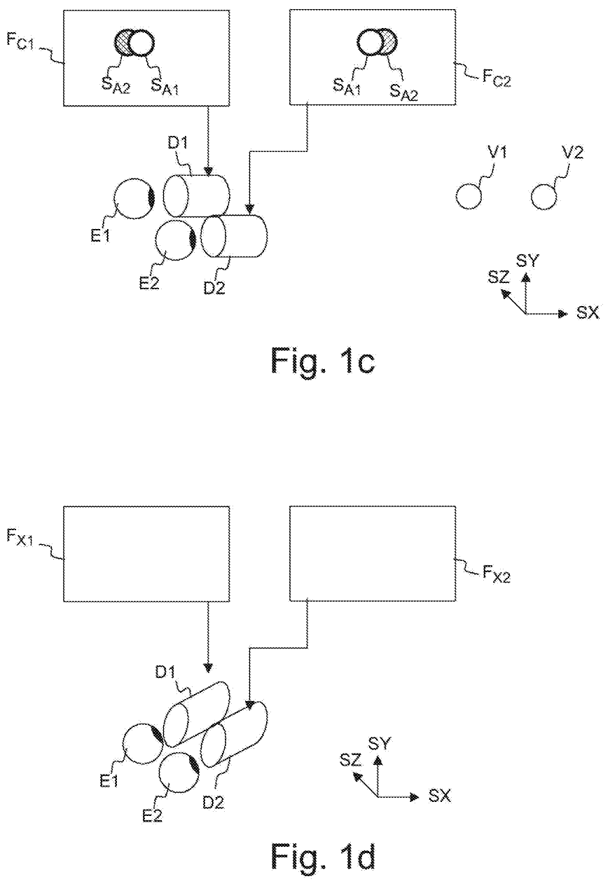

FIGS. 1a, 1b, 1c and 1d show a setup for forming a stereo image to a user. In FIG. 1a, a situation is shown where a human being is viewing two spheres A1 and A2 using both eyes E1 and E2. The sphere A1 is closer to the viewer than the sphere A2, the respective distances to the first eye E1 being L_{E1,A1} and L_{E1,A2}. The different objects reside in space at their respective (x,y,z) coordinates, defined by the coordinate system SZ, SY and SZ. The distance d₁₂ between the eyes of a human being may be approximately 62-64 mm on average, and varying from person to person between 55 and 74 mm. This distance is referred to as the parallax, on which stereoscopic view of the human vision is based on. The viewing directions (optical axes) DIR1 and DIR2 are typically essentially parallel, possibly having a small deviation from being parallel, and define the field of view for the eyes. The head of the user has an orientation (head orientation) in relation to the surroundings, most easily defined by the common direction of the eyes when the eyes are looking straight ahead. That is, the head orientation tells the yaw, pitch and roll of the head in respect of a coordinate system of the scene where the user is.

When the viewer's body (thorax) is not moving, the viewer's head orientation is restricted by the normal anatomical ranges of movement of the cervical spine.

In the setup of FIG. 1a, the spheres A1 and A2 are in the field of view of both eyes. The center-point O₁₂ between the eyes and the spheres are on the same line. That is, from the center-point, the sphere A2 is behind the sphere A1. However, each eye sees part of sphere A2 from behind A1, because the spheres are not on the same line of view from either of the eyes.

In FIG. 1b, there is a setup shown, where the eyes have been replaced by cameras C1 and C2, positioned at the location where the eyes were in FIG. 1a. The distances and directions of the setup are otherwise the same. Naturally, the purpose of the setup of FIG. 1b is to be able to take a stereo image of the spheres A1 and A2. The two images resulting from image capture are F_{C1} and F_{C2}. The “left eye” image F_{C1} shows the image S_{A2} of the sphere A2 partly visible on the left side of the image S_{A1} of the sphere A1. The “right eye” image F_{C2} shows the image S_{A2} of the sphere A2 partly visible on the right side of the image S_{A1} of the sphere A1. This difference between the right and left images is called disparity, and this disparity, being the basic mechanism with which the human visual system determines depth information and creates a 3D view of the scene, can be used to create an illusion of a 3D image.

In this setup of FIG. 1b, where the inter-eye distances correspond to those of the eyes in FIG. 1a, the camera pair C1 and C2 has a natural parallax, that is, it has the property of creating natural disparity in the two images of the cameras. Natural disparity may be understood to be created even though the distance between the two cameras forming the stereo camera pair is somewhat smaller or larger than the normal distance (parallax) between the human eyes, e.g. essentially between 40 mm and 100 mm or even 30 mm and 120 mm.

In FIG. 1c, the creating of this 3D illusion is shown. The images F_{C1} and F_{C2} captured by the cameras C1 and C2 are displayed to the eyes E1 and E2, using displays D1 and D2, respectively. The disparity between the images is processed by the human visual system so that an understanding of depth is created. That is, when the left eye sees the image S_{A2} of the sphere A2 on the left side of the image S_{A1} of sphere A1, and respectively the right eye sees the image of A2 on the right side, the human visual system creates an understanding that there is a sphere V2 behind the sphere V1 in a three-dimensional world. Here, it needs to be understood that the images F_{C1} and F_{C2} can also be synthetic, that is, created by a computer. If they carry the disparity information, synthetic images will also be seen as three-dimensional by the human visual system. That is, a pair of computer-generated images can be formed so that they can be used as a stereo image.

FIG. 1d illustrates how the principle of displaying stereo images to the eyes can be used to create 3D movies or virtual reality scenes having an illusion of being three-dimensional. The images F_{X1} and F_{X2} are either captured with a stereo camera or computed from a model so that the images have the appropriate disparity. By displaying a large number (e.g. 30) frames per second to both eyes using display D1 and D2 so that the images between the left and the right eye have disparity, the human visual system will create a cognition of a moving, three-dimensional image. When the camera is turned, or the direction of view with which the synthetic images are computed is changed, the change in the images creates an illusion that the direction of view is changing, that is, the viewer's head is rotating. This direction of view, that is, the head orientation, may be determined as a real orientation of the head e.g. by an orientation detector mounted on the head, or as a virtual orientation determined by a control device such as a joystick or mouse that can be used to manipulate the direction of view without the user actually moving his head. That is, the term “head orientation” may be used to refer to the actual, physical orientation of the user's head and changes in the same, or it may be used to refer to the virtual direction of the user's view that is determined by a computer program or a computer input device.

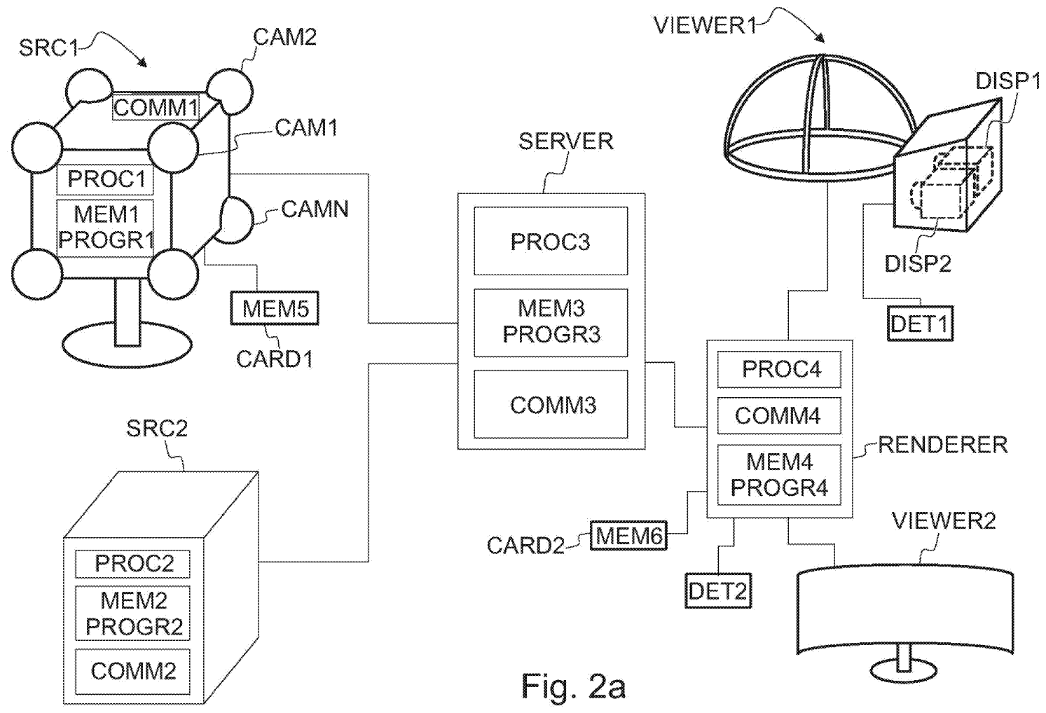

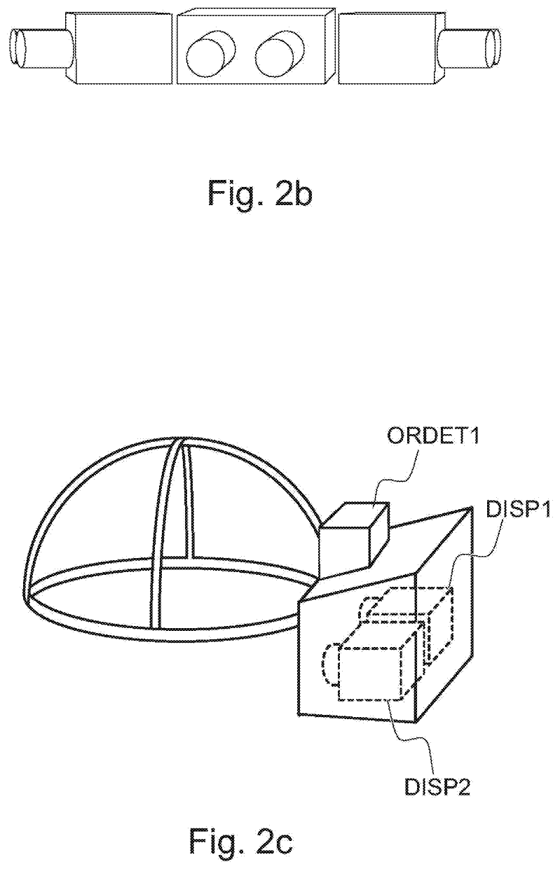

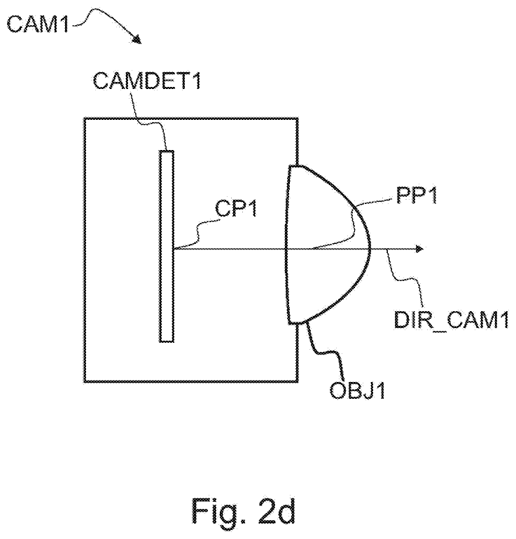

FIG. 2a shows a system and apparatuses for stereo viewing, that is, for 3D video and 3D audio digital capture and playback. The task of the system is that of capturing sufficient visual and auditory information from a specific location such that a convincing reproduction of the experience, or presence, of being in that location can be achieved by one or more viewers physically located in different locations and optionally at a time later in the future. Such reproduction requires more information than can be captured by a single camera or microphone, in order that a viewer can determine the distance and location of objects within the scene using their eyes and their ears. As explained in the context of FIGS. 1a to 1d, to create a pair of images with disparity, two camera sources are used. In a similar manned, for the human auditory system to be able to sense the direction of sound, at least two microphones are used (the commonly known stereo sound is created by recording two audio channels). The human auditory system can detect the cues e.g. in timing difference of the audio signals to detect the direction of sound.

The system of FIG. 2a may consist of three main parts: image sources, a server and a rendering device. A video capture device SRC1 comprises multiple (for example, 8) cameras CAM1, CAM2, . . . , CAMN with overlapping field of view so that regions of the view around the video capture device is captured from at least two cameras. The device SRC1 may comprise multiple microphones to capture the timing and phase differences of audio originating from different directions. The device may comprise a high resolution orientation sensor so that the orientation (direction of view) of the plurality of cameras can be detected and recorded. The device SRC1 comprises or is functionally connected to a computer processor PROC1 and memory MEM1, the memory comprising computer program PROGR1 code for controlling the capture device. The image stream captured by the device may be stored on a memory device MEM2 for use in another device, e.g. a viewer, and/or transmitted to a server using a communication interface COMM1.

It needs to be understood that although an 8-camera-cubical setup is described here as part of the system, another camera device may be used instead as part of the system.

Alternatively or in addition to the video capture device SRC1 creating an image stream, or a plurality of such, one or more sources SRC2 of synthetic images may be present in the system. Such sources of synthetic images may use a computer model of a virtual world to compute the various image streams it transmits. For example, the source SRC2 may compute N video streams corresponding to N virtual cameras located at a virtual viewing position. When such a synthetic set of video streams is used for viewing, the viewer may see a three-dimensional virtual world, as explained earlier for FIG. 1d. The device SRC2 comprises or is functionally connected to a computer processor PROC2 and memory MEM2, the memory comprising computer program PROGR2 code for controlling the synthetic source device SRC2. The image stream captured by the device may be stored on a memory device MEM5 (e.g. memory card CARD1) for use in another device, e.g. a viewer, or transmitted to a server or the viewer using a communication interface COMM2.

There may be a storage, processing and data stream serving network in addition to the capture device SRC1. For example, there may be a server SERV or a plurality of servers storing the output from the capture device SRC1 or computation device SRC2. The device comprises or is functionally connected to a computer processor PROC3 and memory MEM3, the memory comprising computer program PROGR3 code for controlling the server. The server may be connected by a wired or wireless network connection, or both, to sources SRC1 and/or SRC2, as well as the viewer devices VIEWER1 and VIEWER2 over the communication interface COMM3.

For viewing the captured or created video content, there may be one or more viewer devices VIEWER1 and VIEWER2. These devices may have a rendering module and a display module, or these functionalities may be combined in a single device. The devices may comprise or be functionally connected to a computer processor PROC4 and memory MEM4, the memory comprising computer program PROGR4 code for controlling the viewing devices. The viewer (playback) devices may consist of a data stream receiver for receiving a video data stream from a server and for decoding the video data stream. The data stream may be received over a network connection through communications interface COMM4, or from a memory device MEM6 like a memory card CARD2. The viewer devices may have a graphics processing unit for processing of the data to a suitable format for viewing as described with FIGS. 1c and 1d. The viewer VIEWER1 comprises a high-resolution stereo-image head-mounted display for viewing the rendered stereo video sequence. The head-mounted device may have an orientation sensor DET1 and stereo audio headphones. The viewer VIEWER2 comprises a display enabled with 3D technology (for displaying stereo video), and the rendering device may have a head-orientation detector DET2 connected to it. Any of the devices (SRC1, SRC2, SERVER, RENDERER, VIEWER1, VIEWER2) may be a computer or a portable computing device, or be connected to such. Such rendering devices may have computer program code for carrying out methods according to various examples described in this text.

FIG. 2b shows a camera device for stereo viewing. The camera comprises three or more cameras that are configured into camera pairs for creating the left and right eye images, or that can be arranged to such pairs. The distance between cameras may correspond to the usual distance between the human eyes. The cameras may be arranged so that they have significant overlap in their field-of-view. For example, wide-angle lenses of 180 degrees or more may be used, and there may be 3, 4, 5, 6, 7, 8, 9, 10, 12, 16 or 20 cameras. The cameras may be regularly or irregularly spaced across the whole sphere of view, or they may cover only part of the whole sphere. For example, there may be three cameras arranged in a triangle and having different directions of view towards one side of the triangle such that all three cameras cover an overlap area in the middle of the directions of view. As another example, 8 cameras having wide-angle lenses and arranged regularly at the corners of a virtual cube and covering the whole sphere such that the whole or essentially whole sphere is covered at all directions by at least 3 or 4 cameras. In FIG. 2b, three stereo camera pairs are shown.

Camera devices with other types of camera layouts may be used. For example, a camera device with all the cameras in one hemisphere may be used. The number of cameras may be e.g. 3, 4, 6, 8, 12, or more. The cameras may be placed to create a central field of view where stereo images can be formed from image data of two or more cameras, and a peripheral (extreme) field of view where one camera covers the scene and only a normal non-stereo image can be formed. Examples of different camera devices that may be used in the system are described also later in this description.

FIG. 2c shows a head-mounted display for stereo viewing. The head-mounted display contains two screen sections or two screens DISP1 and DISP2 for displaying the left and right eye images. The displays are close to the eyes, and therefore lenses are used to make the images easily viewable and for spreading the images to cover as much as possible of the eyes' field of view. The device is attached to the head of the user so that it stays in place even when the user turns his head. The device may have an orientation detecting module ORDET1 for determining the head movements and direction of the head. It is to be noted here that in this type of a device, tracking the head movement may be done, but since the displays cover a large area of the field of view, eye movement detection is not necessary. The head orientation may be related to real, physical orientation of the user's head, and it may be tracked by a sensor for determining the real orientation of the user's head. Alternatively or in addition, head orientation may be related to virtual orientation of the user's view direction, controlled by a computer program or by a computer input device such as a joystick. That is, the user may be able to change the determined head orientation with an input device, or a computer program may change the view direction (e.g. in gaming, the game program may control the determined head orientation instead or in addition to the real head orientation.

FIG. 2d illustrates a camera CAM1. The camera has a camera detector CAMDET1, comprising a plurality of sensor elements for sensing intensity of the light hitting the sensor element. The camera has a lens OBJ1 (or a lens arrangement of a plurality of lenses), the lens being positioned so that the light hitting the sensor elements travels through the lens to the sensor elements. The camera detector CAMDET1 has a nominal center point CP1 that is a middle point of the plurality sensor elements, for example for a rectangular sensor the crossing point of the diagonals. The lens has a nominal center point PP1, as well, lying for example on the axis of symmetry of the lens. The direction of orientation of the camera is defined by the line passing through the center point CP1 of the camera sensor and the center point PP1 of the lens. The direction of the camera is a vector along this line pointing in the direction from the camera sensor to the lens. The optical axis of the camera is understood to be this line CP1-PP1.

The system described above may function as follows. Time-synchronized video, audio and orientation data is first recorded with the capture device. This can consist of multiple concurrent video and audio streams as described above. These are then transmitted immediately or later to the storage and processing network for processing and conversion into a format suitable for subsequent delivery to playback devices. The conversion can involve post-processing steps to the audio and video data in order to improve the quality and/or reduce the quantity of the data while preserving the quality at a desired level. Finally, each playback device receives a stream of the data from the network, and renders it into a stereo viewing reproduction of the original location which can be experienced by a user with the head mounted display and headphones.

In the following a method for creating stereo images is described. With the method, the user may be able to turn their head in multiple directions, and the playback device is able to create a high-frequency (e.g. 60 frames per second) stereo video and audio view of the scene corresponding to that specific orientation as it would have appeared from the location of the original recording. Other methods of creating the stereo images for viewing from the camera data may be used, as well.

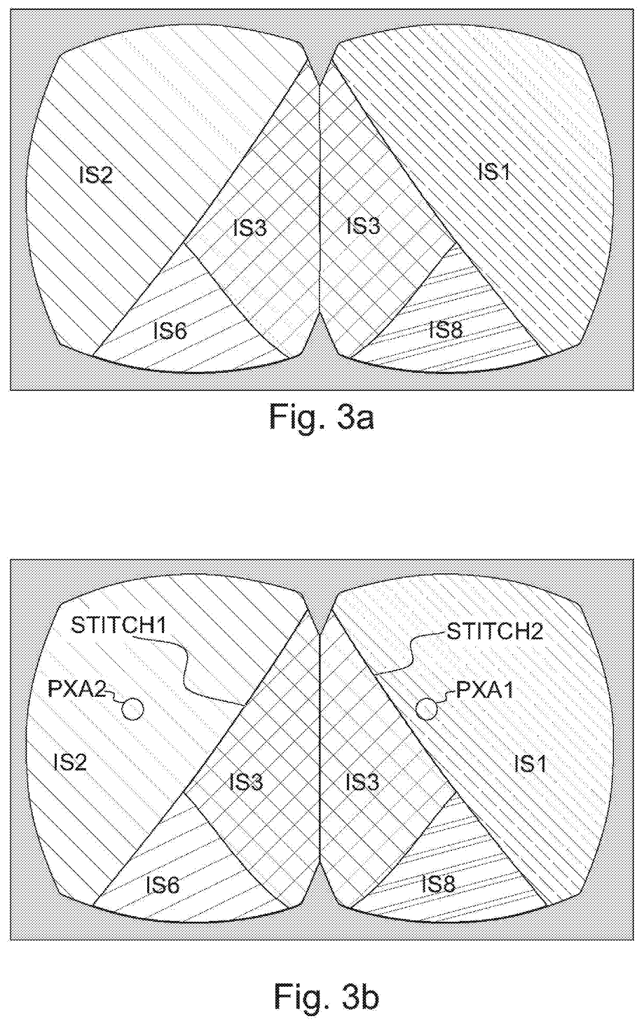

FIGS. 3a and 3b illustrate forming stereo images for first and second eye from image sources by using dynamic source selection and dynamic stitching location. In order to create a stereo view for a specific head orientation, image data from at least 2 different cameras is used. Typically, a single camera is not able to cover the whole field of view. Therefore, according to the present solution, multiple cameras may be used for creating both images for stereo viewing by stitching together sections of the images from different cameras. The image creation by stitching happens so that the images have an appropriate disparity so that a 3D view can be created. This will be explained in the following.

For using the best image sources, a model of camera and eye positions is used. The cameras may have positions in the camera space, and the positions of the eyes are projected into this space so that the eyes appear among the cameras. A realistic (natural) parallax (distance between the eyes) is employed. For example, in a setup where all the cameras are located on a sphere, the eyes may be projected on the sphere, as well. The solution first selects the closest camera to each eye. Head-mounted-displays can have a large field of view per eye such that there is no single image (from one camera) which covers the entire view of an eye. In this case, a view must be created from parts of multiple images, using a known technique of “stitching” together images along lines which contain almost the same content in the two images being stitched together. FIG. 3a shows the two displays for stereo viewing. The image of the left eye display is put together from image data from cameras IS2, IS3 and IS6. The image of the right eye display is put together from image data from cameras IS1, IS3 and IS8. Notice that the same image source IS3 is in this example used for both the left eye and the right eye image, but this is done so that the same region of the view is not covered by camera IS3 in both eyes. This ensures proper disparity across the whole view—that is, at each location in the view, there is a disparity between the left and right eye images.

The stitching point is changed dynamically for each head orientation to maximize the area around the central region of the view that is taken from the nearest camera to the eye position. At the same time, care is taken to ensure that different cameras are used for the same regions of the view in the two images for the different eyes. In FIG. 3b, the regions PXA1 and PXA2 that correspond to the same area in the view are taken from different cameras IS1 and IS2, respectively. The two cameras are spaced apart, so the regions PXA1 and PXA2 show the effect of disparity, thereby creating a 3D illusion in the human visual system. Seams (which can be more visible) STITCH1 and STITCH2 are also avoided from being positioned in the center of the view, because the nearest camera will typically cover the area around the center. This method leads to dynamic choosing of the pair of cameras to be used for creating the images for a certain region of the view depending on the head orientation. The choosing may be done for each pixel and each frame, using the detected head orientation.

The stitching is done with an algorithm ensuring that all stitched regions have proper stereo disparity. The left and right images may be stitched together so that the objects in the scene continue across the areas from different camera sources.

The same camera image may be used partly in both left and right eyes but not for the same region. For example the right side of the left eye view can be stitched from camera IS3 and the left side of the right eye can be stitched from the same camera IS3, as long as those view areas are not overlapping and different cameras (IS1 and IS2) are used for rendering those areas in the other eye. In other words, the same camera source (in FIG. 3a, IS3) may be used in stereo viewing for both the left eye image and the right eye image. In traditional stereo viewing, on the contrary, the left camera is used for the left image and the right camera is used for the right image. Thus, the present method allows the source data to be utilized more fully. This can be utilized in the capture of video data, whereby the images captured by different cameras at different time instances (with a certain sampling rate like 30 frames per second) are used to create the left and right stereo images for viewing. This may be done such a manner that the same camera image captured at a certain time instance is used for creating part of an image for the left eye and part of an image for the right eye, the left and right eye images being used together to form one stereo frame of a stereo video stream for viewing. At different time instances, different cameras may be used for creating part of the left eye and part of the right eye frame of the video. This enables much more efficient use of the captured video data.

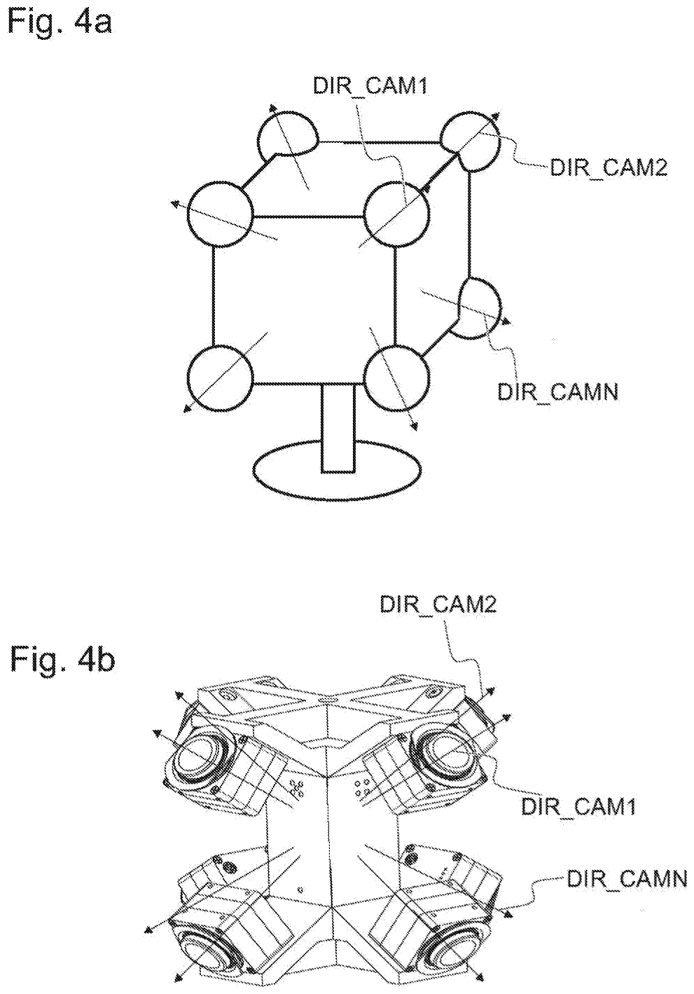

FIGS. 4a and 4b show an example of a camera device for being used as an image source. To create a full 360 degree stereo panorama every direction of view needs to be photographed from two locations, one for the left eye and one for the right eye. In case of video panorama, these images need to be shot simultaneously to keep the eyes in sync with each other. As one camera cannot physically cover the whole 360 degree view, at least without being obscured by another camera, there need to be multiple cameras to form the whole 360 degree panorama. Additional cameras however increase the cost and size of the system and add more data streams to be processed. This problem becomes even more significant when mounting cameras on a sphere or platonic solid shaped arrangement to get more vertical field of view. However, even by arranging multiple camera pairs on for example a sphere or platonic solid such as octahedron or dodecahedron, the camera pairs will not achieve free angle parallax between the eye views. The parallax between eyes is fixed to the positions of the individual cameras in a pair, that is, in the perpendicular direction to the camera pair, no parallax can be achieved. This is problematic when the stereo content is viewed with a head mounted display that allows free rotation of the viewing angle around z-axis as well.

The requirement for multiple cameras covering every point around the capture device twice would require a very large number of cameras in the capture device. In this technique lenses are used with a field of view of 180 degree (hemisphere) or greater, and the cameras are arranged with a carefully selected arrangement around the capture device. Such an arrangement is shown in FIG. 4a, where the cameras have been positioned at the corners of a virtual cube, having orientations DIR_CAM1, DIR_CAM2, . . . , DIR_CAMN essentially pointing away from the center point of the cube. Naturally, other shapes, e.g. the shape of a cuboctahedron, or other arrangements, even irregular ones, can be used.

Overlapping super wide field of view lenses may be used so that a camera can serve both as the left eye view of a camera pair and as the right eye view of another camera pair. This reduces the amount of needed cameras to half. As a surprising advantage, reducing the number of cameras in this manner increases the stereo viewing quality, because it also allows to pick the left eye and right eye cameras arbitrarily among all the cameras as long as they have enough overlapping view with each other. Using this technique with different number of cameras and different camera arrangements such as sphere and platonic solids enables picking the closest matching camera for each eye (as explained earlier) achieving also vertical parallax between the eyes. This is beneficial especially when the content is viewed using head mounted display. The described camera setup, together with the stitching technique described earlier, may allow creating stereo viewing with higher fidelity and smaller expenses of the camera device.

The wide field of view allows image data from one camera to be selected as source data for different eyes depending on the current view direction, minimizing the needed number of cameras. The spacing can be in a ring of 5 or more cameras around one axis in the case that high image quality above and below the device is not required, nor view orientations tilted from perpendicular to the ring axis.

In case high quality images and free view tilt in all directions is required, for example a cube (with 6 cameras), octahedron (with 8 cameras) or dodecahedron (with 12 cameras) may be used. Of these, the octahedron, or the corners of a cube (FIG. 4a) is a possible choice since it offers a good trade-off between minimizing the number of cameras while maximizing the number of camera-pairs combinations that are available for different view orientations. An actual camera device built with 8 cameras is shown in FIG. 4b. The camera device uses 185-degree wide angle lenses, so that the total coverage of the cameras is more than 4 full spheres. This means that all points of the scene are covered by at least 4 cameras. The cameras have orientations DIR_CAM1, DIR_CAM2, . . . , DIR_CAMN pointing away from the center of the device.

Even with fewer cameras, such over-coverage may be achieved, e.g. with 6 cameras and the same 185-degree lenses, coverage of 3× can be achieved. When a scene is being rendered and the closest cameras are being chosen for a certain pixel, this over-coverage means that there are always at least 3 cameras that cover a point, and consequently at least 3 different camera pairs for that point can be formed. Thus, depending on the view orientation (head orientation), a camera pair with a good parallax may be more easily found.

The camera device may comprise at least three cameras in a regular or irregular setting located in such a manner with respect to each other that any pair of cameras of said at least three cameras has a disparity for creating a stereo image having a disparity. The at least three cameras have overlapping fields of view such that an overlap region for which every part is captured by said at least three cameras is defined. Any pair of cameras of the at least three cameras may have a parallax corresponding to parallax of human eyes for creating a stereo image. For example, the parallax (distance) between the pair of cameras may be between 5.0 cm and 12.0 cm, e.g. approximately 6.5 cm. Such a parallax may be understood to be a natural parallax or close to a natural parallax, due to the resemblance of the distance to the normal inter-eye distance of humans. The at least three cameras may have different directions of optical axis. The overlap region may have a simply connected topology, meaning that it forms a contiguous surface with no holes, or essentially no holes so that the disparity can be obtained across the whole viewing surface, or at least for the majority of the overlap region. In some camera devices, this overlap region may be the central field of view around the viewing direction of the camera device. The field of view of each of said at least three cameras may approximately correspond to a half sphere. The camera device may comprise three cameras, the three cameras being arranged in a triangular setting, whereby the directions of optical axes between any pair of cameras form an angle of less than 90 degrees. The at least three cameras may comprise eight wide-field cameras positioned essentially at the corners of a virtual cube and each having a direction of optical axis essentially from the center point of the virtual cube to the corner in a regular manner, wherein the field of view of each of said wide-field cameras is at least 180 degrees, so that each part of the whole sphere view is covered by at least four cameras (see FIG. 4b).

The human interpupillary (IPD) distance of adults may vary approximately from 52 mm to 78 mm depending on the person and the gender. Children have naturally smaller IPD than adults. The human brain adapts to the exact IPD of the person but can tolerate quite well some variance when rendering stereoscopic view. The tolerance for different disparity is also personal but for example 80 mm disparity in image viewing does not seem to cause problems in stereoscopic vision for most of the adults. Therefore, the optimal distance between the cameras is roughly the natural 60-70 mm disparity of an adult human being but depending on the viewer, the invention works with much greater range of distances, for example with distances from 40 mm to 100 mm or even from 30 mm to 120 mm. For example, 80 mm may be used to be able to have sufficient space for optics and electronics in a camera device, but yet to be able to have a realistic natural disparity for stereo viewing.

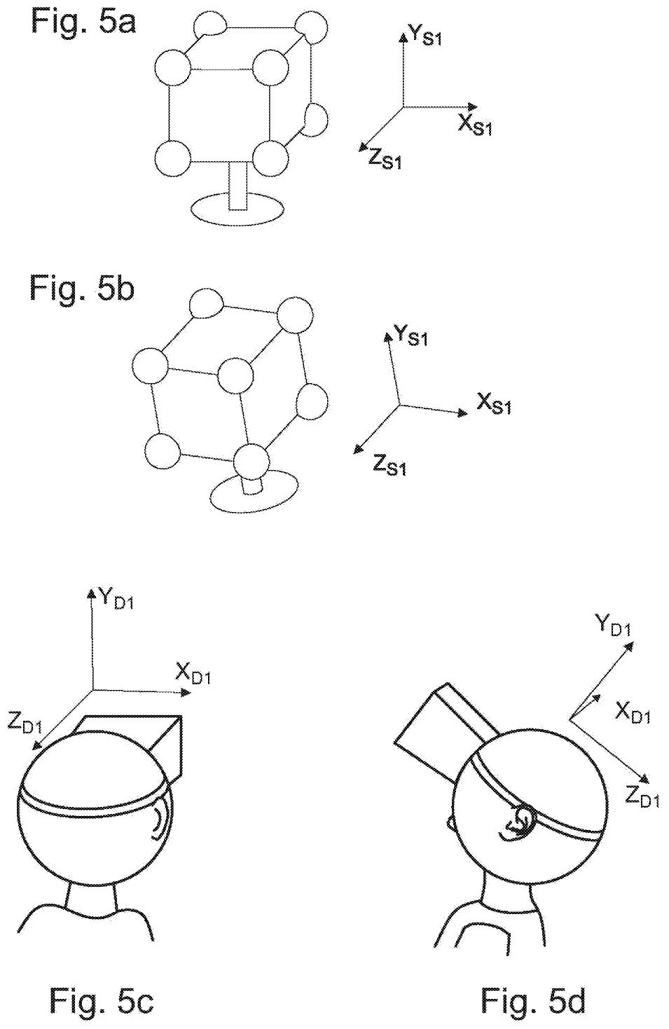

FIGS. 5a to 5d show the use of source (S) and destination (D) coordinate systems for stereo viewing. A technique used here is to record the capture device orientation synchronized with the overlapping video data, and use the orientation information to correct the orientation of the view presented to user—effectively cancelling out the rotation of the capture device during playback—so that the user is in control of the viewing direction, not the capture device. If the viewer instead wishes to experience the original motion of the capture device, the correction may be disabled. If the viewer wishes to experience a less extreme version of the original motion—the correction can be applied dynamically with a filter so that the original motion is followed but more slowly or with smaller deviations from the normal orientation.

FIG. 5a illustrates the rotation of the camera device, and the rotation of the camera coordinate system. Naturally, the view and orientation of each camera is changing, as well, and consequently, even though the viewer stays in the same orientation as before, he will see a rotation to the left. If at the same time, as shown in FIG. 5b, the user were to rotate his head to the left, the resulting view would turn even more heavily to the left, possibly changing the view direction by 180 degrees. However, if the movement of the camera device is cancelled, the user's head movement (see FIGS. 5c and 5d) will be the one controlling the view. In the example of the scuba diver, the viewer can pick the objects to look at regardless of what the diver has been looking at. That is, the orientation of the image source is used together with the orientation of the head of the user to determine the images to be displayed to the user.

In the following, a family of related multi-camera arrangements for camera devices using between 4 and 12 cameras, and e.g. wide-angle fish-eye lenses, are described. This family of camera devices may have benefits for creating 3D visual recordings intended for viewing with head-mounted displays.

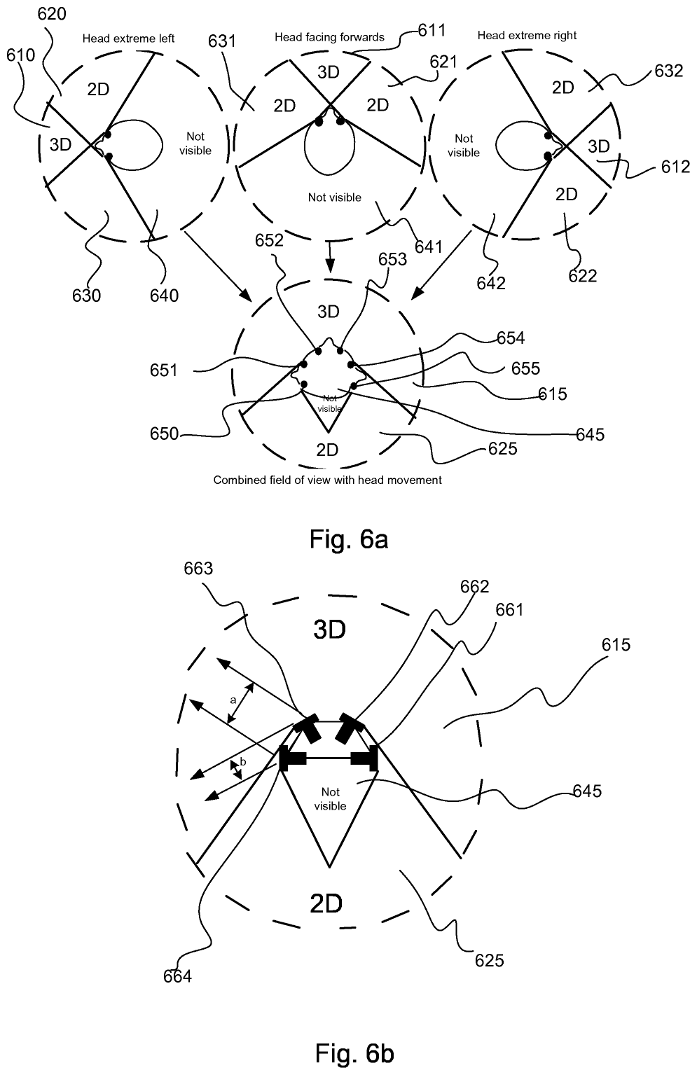

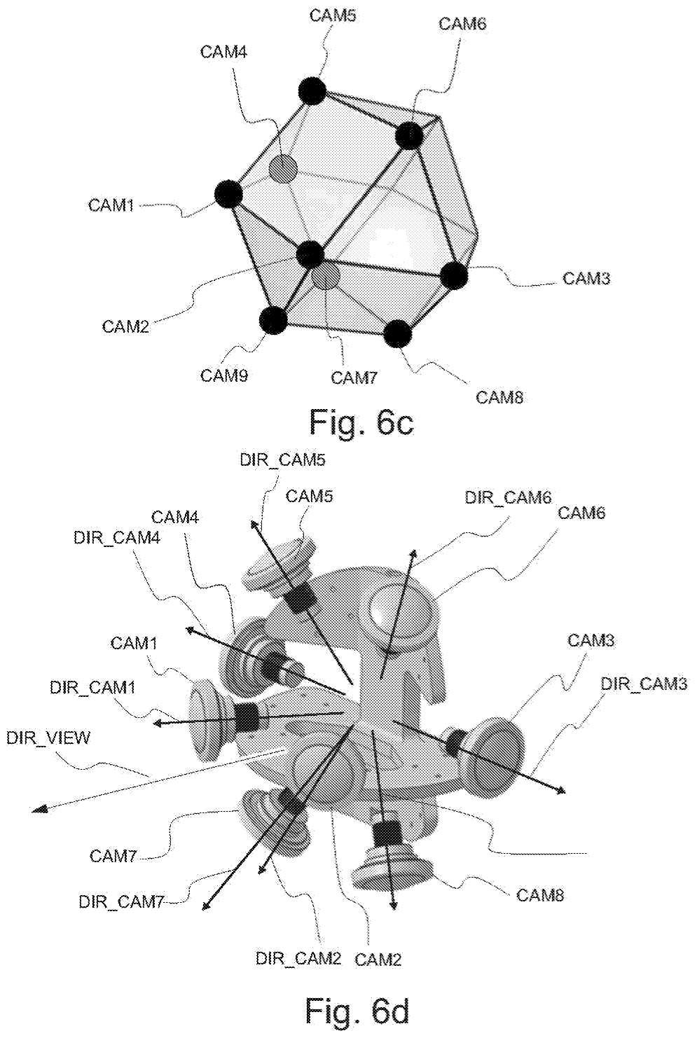

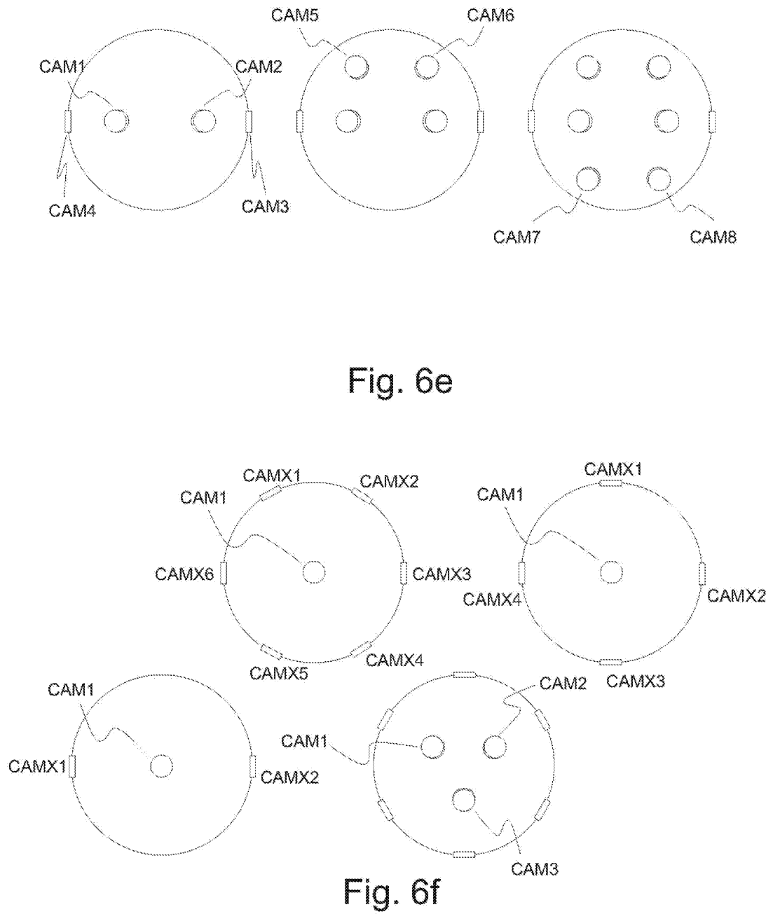

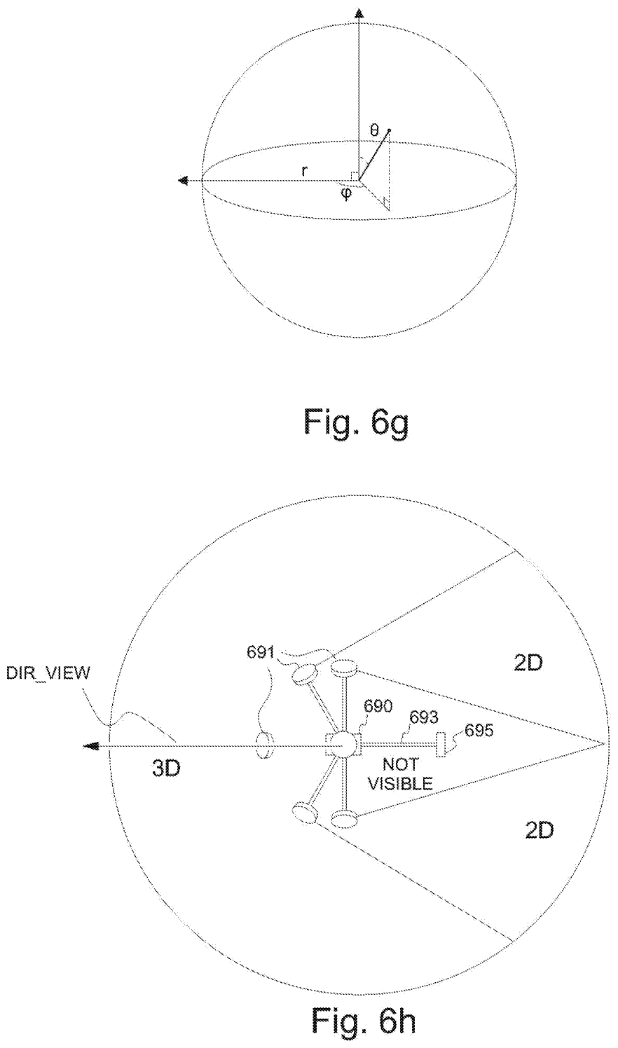

FIG. 6a illustrates a camera device formed to mimic the human vision with head-turn. In the present context, we have observed that when viewing a scene with a head mounted display, the typical range of motion of the head, without the rest of the body turning, is constrained to one hemisphere. That is, people using head mounted displays are using their head to turn their head in this hemisphere, but are not using their bodies to turn to view to the back. Due to the field of view of the eyes, this hemispheric motion of the head still gives easy visibility of a full sphere, but the area of that sphere which is viewed in 3D is only slightly larger than a hemisphere since the rear area is only ever seen from one eye.

FIG. 6a shows the ranges of 3D vision 610, 611 and 612 when the head is rotated to the left, to the center and to the right, respectively. The total three-dimensional field of view 615 is somewhat larger than a half circle in the horizontal plane. The back of the head can be seen as the combination of the areas 620, 621, 622, 630, 631 and 632, with the 3D area subtracted, resulting in the 2D viewing area 625. Due to the restricted view to the back, in addition to not being able to see inside his head (behind the eyes), the person is not able to see a small wedge-shaped area 645 in the back, also covering an area outside the head. When wide-angle cameras are placed in some of the locations 650, 651, 652, 653, 654 and 655 of the eyes, a similar central field of view 615 and peripheral field of view 625 can be captured for stereo viewing.

Similarly, cameras may be placed in locations of the eyes when the head is tilted up and/or down. For example, a camera device may comprise cameras at locations essentially corresponding to eye positions of a human head at normal anatomical posture and at maximum left and right rotation anatomical postures as above, and in addition at maximum flexion anatomical posture (tilted down), at maximum extension anatomical posture (tilted up). The eye positions may also be projected on a virtual sphere of radius of 50-100 mm, for example 80 mm, for more compact spacing of the cameras (i.e. to reduce the size of the camera device).

When the viewer's body (thorax) is not moving, the viewer's head orientation is restricted by the normal anatomical ranges of movement of the cervical spine. These may be for example as follows. The head may be normally able to rotate around the vertical axis 90 degrees to either side. The normal range of flexion may be up to 90 degrees, that is, the viewer may be able to tilt his head down by 90 degrees, depending on his personal anatomy. The normal range of extension may be up to 70 degrees, that is, the viewer may be able to tilt his head up by 70 degrees. The normal range of lateral flexion may be up to 45 degrees or less, e.g. 30 degrees, to either side, that is, the user may be able to tilt his head to the side by a maximum of 30-45 degrees. Any rotation, flexion or extension of the thorax (and the lower spine) may increase these normal ranges of movement.

In an example shown in FIG. 6b, 4 cameras 661, 662, 663 and 664 are arranged on 4 adjacent vertices of a regular hexagon, with optical axes going through the center point of the hexagon, at a distance such that the focal point of each camera system is positioned at a distance of not less than 64 mm, and not greater than 90 mm, from the adjacent cameras.

For 3D images viewed in the average direction between 2 cameras, the disparity, caused by distance “a” (parallax) in FIG. 6b, is at a maximum, and matches the distance between the focal points of those cameras. This distance would typically be slightly greater than 65 mm so that the average disparity of the system matches the average human eye separation.

As the view direction approaches the extreme edge of the 3D field, the disparity (distance “b” in FIG. 6b)—and hence the human depth perception—reduces due to the geometry of the system. Beyond a predetermined viewing angle, the 3D view made from 2 cameras is replaced by a 2D view from a single camera. The natural reduction of disparity prior to this change is advantageous since it results in a smoother and less noticeable changeover from 3D to 2D viewing.

There is a region of non-visibility behind the camera system, the exact extent of which is determined by the positions and directions of the extreme (peripheral) cameras 661 and 664, and their field-of-view. This region is advantageous since it represents a significant volume which can be used, for example, for mechanics, batteries, data storage, or other supporting equipment which will not be visible in the final captured visual environment.

The camera devices described here in context of FIGS. 6a-6h have a viewing direction, e.g. camera devices of FIGS. 6a and 6b have a viewing direction directly ahead (in the figures, straight up). The camera devices have a plurality of cameras, comprising at least one central camera and at least two peripheral cameras. For example, in FIG. 6b, cameras 662 and 663 are central cameras and 661 and 664 are peripheral (extreme) cameras. Each camera has a respective field of view defined by its optical axis and angle of view of the lens. In these camera devices, each said field of view covers the view direction of the camera device, because wide-angle lenses are used. The plurality of cameras are positioned with respect to each other such that the central and peripheral cameras form at least two stereo camera pairs with a natural disparity, so that depending on the viewing direction, the appropriate stereo camera pair can be used for creating the stereo image. Each stereo camera pair has a respective stereo field of view. The stereo fields of view also cover the view direction of the camera device when the cameras are appropriately located. The camera device as a whole has a central field of view 615, this being a combined stereo field of view of the stereo fields of view of the stereo camera pairs. The central field of view 615 comprises the view direction. The camera device also has a peripheral field of view 625, this being a combined field of view of the fields of view of all the cameras, except the central field of view, that is, at least partly outside the central field of view. As an example, a camera device may have central field of view extending 100 to 120 degrees to both sides of the view direction of the camera device at least in one plane comprising the view direction of the camera device.

In here, the central field of view can be understood to be a field of view where a stereo image can be formed using images captured by at least one camera pair. The peripheral field of view is a field of view where an image can be formed using at least one camera, but a stereo image cannot be formed, because a suitable stereo camera pair does not exist. A feasible arrangement with respect to the fields of view of the cameras is such that the camera device has a center area or center point, and the plurality of cameras have their respective optical axes non-parallel with respect to each other and passing through the center. That is, the cameras are pointing directly outwards from the center.

A cuboctahedral shape is shown in FIG. 6c. A cuboctahedron consists of a hexagon, with an equilateral triangle above and below the hexagon, the triangles' vertices connected to the closest vertices of the hexagon. All vertices are equally spaced from their closest neighbours. One of the upper or lower triangles can be rotated 30 degrees around the vertical axis with respect to the other to obtain a modified cuboctahedral shape that presents symmetry with respect to the middle hexagon plane. Cameras may be placed in the front hemisphere of the cuboctahedron. Four cameras CAM1, CAM2, CAM3, CAM4 are at the vertices of the middle hexagon, two cameras CAM5, CAM6 are above it and three cameras CAM7, CAM8, CAM9 are below it.

An example eight camera system is shown as a 3D mechanical drawing in FIG. 6d, with the camera device support structure present. The cameras are attached to the support structure that has positions for the cameras. In this camera system, the lower triangle of the cuboctahedron has been rotated to have two cameras in the hemisphere around the viewing direction of the camera device (the mirroring described in FIG. 6e).

In this and other camera devices of FIGS. 6a-6h, a camera device has a number of cameras, and they may be placed on an essentially spherical virtual surface (e.g. a hemisphere around the view direction DIR_VIEW). In such an arrangement, all or some of the cameras may have their respective optical axes passing through or approximately passing through the center point of the virtual sphere. A camera device may have, like in FIGS. 6c and 6d, a first central camera CAM2 and a second central camera CAM1 with their optical axes DIR_CAM2 and DIR_CAM1 displaced on a horizontal plane (the plane of the middle hexagon) and having a natural disparity. There may also be a first peripheral camera CAM3 having its optical axis DIR_CAM3 on the horizontal plane oriented to the left of the optical axis of central camera DIR_CAM2, and a second peripheral camera having its optical axis DIR_CAM4 on the horizontal plane oriented to the right of the optical axis of central camera DIR_CAM1. In this arrangement, the optical axes of the first peripheral camera and the first central camera, the optical axes of the first central camera and the second central camera, and the optical axes of the second central camera and the second peripheral camera, form approximately 60 degree angles, respectively. In the setting of FIG. 6d, two peripheral cameras are opposite to each other (or approximately opposite) and their optical axes are aligned albeit of opposite direction. In such an arrangement, with wide angle lenses, the fields of the two peripheral cameras may cover the full sphere, possibly with some overlap.

In FIG. 6d, the camera device also has the two central cameras CAM1 and CAM2 and four peripheral cameras CAM3, CAM4, CAM5, CAM6 disposed at the vertices of an upper front quarter of a virtual cuboctahedron and two peripheral cameras CAM7 and CAM8 disposed at locations mirrored with respect to the equatorial plane (plane of the middle hexagon) of the upper front quarter of the cuboctahedron. The optical axes DIR_CAM5, DIR_CAM6, DIR_CAM7, DIR_CAM8 of these off-equator cameras may also be passing through the center of the camera device.

Directions and locations of the individual cameras of FIG. 6d have been described in the following with respect to the spherical coordinate system of FIG. 6g. The coordinates of the locations (r, θ, φ) of the cameras CAM1-CAM8 are, respectively: (R,90°,60°), (R,90°,120°), (R,90°,180°), (R,90°,0°), (R,35.3°,30°), (R,35.3°,30°), (R,144.7°,30°), (R,144.7°,150°), where R=70 mm. The directions (θ, φ) of the optical axes are, respectively: (90°,60°), (90°,120°), (90°,180°), (90°,0°), (35.3°,30°), (35.3°,150°), (144.7°,30°), (144.7°,150°).

FIGS. 6e and 6f show different camera setups for a camera device where the viewing direction of the camera device (and the hemisphere containing the cameras) is facing directly towards the viewer of the Figures.

As shown in FIG. 6e, a minimal cuboctahedral camera setup consists of the four cameras CAM1, CAM2, CAM3, CAM4 on the middle plane. The viewing direction is thus the mean of the optical directions of the central cameras CAM1 and CAM2. Additional cameras may be placed in a number of ways to increase the useful data that may be gathered. In a six camera configuration, a pair of cameras CAM5 and CAM6 may be placed on two of the triangular vertices above the hexagon, with optical axes meeting at the center of the system and forming a square with respect to the central two cameras CAM1 and CAM2 of the main hexagonal ring. In an eight camera configuration, two more cameras CAM7 and CAM8 may mirror the two cameras CAM5 and CAM6 with respect to the middle hexagon plane. With 4 cameras as described earlier in FIG. 6e, the 3D range is extended by the angle of the offset of the front cameras from the forward direction. A typical per-camera angular separation would be 60 degrees—this adds 60 degrees to the camera field of view to give the overall 3D field of view of more than 240 degrees, and up to 255 degrees in the case of a typical commercially available 195 degree field of view lens. A six-camera system allows a high quality 3D view to be shown during upward pitch of the head from the center position. An eight-camera system allows the same below, and is the arrangement giving a good overall match for normal head motion, including also vertical motion.

Non-uniform camera arrangements may also be used. For example, camera devices with greater than 60 degree separation of optical axes between cameras, or fewer degrees of separation but additional cameras may be envisioned.

With only 3 cameras, 1 facing forward in the view direction of the camera device (CAM1 of bottom left FIG. 6f) and 2 at 90 degrees to each side (CAMX1, CAMX2), the range of 3D vision is limited by the field of view of the front camera, but is typically less than the 3D vision range due to head motion. Furthermore, with this camera setup, vertical disparity cannot be created (the viewer tilting his head to the side). This vertical disparity may be implemented by adding vertically displaced cameras to the setup, e.g. as in the upper right setup of FIG. 6f, where the peripheral cameras CAMX1 and CAMX3 are at the top and bottom of the hemisphere at or close to the edge of the hemisphere, and peripheral cameras CAMX2 and CAMX4 are on the horizontal plane. Again, the central camera CAM1 points to the view direction of the camera device. The upper left setup has six peripheral cameras CAMX1, CAMX2, CAMX3, CAMX4, CAMX5 and CAMX6 at or close to the edge of the hemisphere. It is also feasible to use two, three, four or more central cameras CAM1, CAM2, CAM3 as in the lower right setup of FIG. 6f. This may increase the quality of the stereo image in the viewing direction of the camera device, because two or more central cameras can be used and the viewing direction is captured essentially in the center of the fields of view of these cameras such that no stitching is needed in the middle of the image (stitching is described earlier).

In the camera devices of the FIGS. 6a-6h, the individual cameras are disposed on a spherical or essentially spherical virtual surface. The cameras are located on one hemisphere of the virtual surface, or an area that is somewhat (e.g. 20 degrees) smaller or larger in spatial angle than a hemisphere. No cameras are disposed on the other hemisphere of the virtual sphere. As described, this leaves optically invisible space for mechanics and electronics at the back. In the camera devices, central cameras are disposed in the middle of the hemisphere (close to the view direction of the camera device) and the peripheral cameras are disposed close to the edges of the hemisphere.

Non uniform arrangements with different separation values can also be used, but these either reduce the quality of the data for reproducing head motion, or else require more cameras to be added increasing the complexity of the implementation.

FIG. 6g shows a spherical coordinate system with respect to which the camera locations and directions of their optical axes has been described above. The distance from the center point is given by the coordinate r. From a reference direction, the rotation around the vertical axis of a point in space is given by the angle φ (phi). The rotational offset from the vertical axis is given by the angle θ (theta).

FIG. 6h shows an example structure of a camera device and its fields of view. There is a support structure 690 with a housing or space for electronics and support arms or cradles for the cameras 691. Furthermore, there may be a support 693 for the camera device, and at the other end of the support, a handle for holding or a fixing plate 695 or other device for holding or fixing the camera device to an object (e.g. a car or a stand). As explained earlier, the camera device has a view direction DIR_VIEW, and a central field of view (3D), as well as a peripheral field of view (2D). At the back of the camera device, there may be a space, an enclosure or such for holding electronics, mechanical structures etc. Due to the asymmetric camera arrangement wherein the cameras are placed in one hemisphere of the camera device (around the view direction), there is a space of no visibility behind the camera device (marked NOT VISIBLE in FIG. 6h).

When using a camera system with multiple cameras (i.e. multiple camera sensors), perception of colors becomes a fundamental issue to be solved. This is due to differences on how colors are perceived by individuals. These differences are remarkable in a small geographical area, but they become even more significant between various areas of the globe. In addition, so-called color memory influences perceived color reality of the same individual, such that even basic perception of surrounding basic colors is altered by the passing of time and by various illnesses. When multiple camera sensors are used for capturing image data, individual sensors forming the capturing system do not usually have consistent color responses. These inconsistencies between individual sensors can cause large color discrepancies, which can increase the user discomfort and decrease the quality of playback of the image data. In the present description, user is allowed to select for image data captured with single or multiple color sensitive sensors the actual scene coloring, precise scene coloring at the moment of shooting versus a specific color target shift for color pleasantness. Color consistency of the sensors is achieved by calibrating the sensors individually by using the same set of color targets.

Capturing a reality scene can be done statically or dynamically.

In static capturing only one capturing scene may be used for single or multiple captures. When multiple captures are taken of the same scene with one camera sensor, the camera may be configured to vary some of sensor's parameters, wherein the resulted captures can be combined and processed to achieve a better output, e.g. with higher dynamic range. An example of such technique is bracketing, e.g. exposure bracketing. Although the results can be impressive, the imposed restrictions, e.g. to shoot the same area of the scene several times as quickly as possible to avoid any movement distortion, can be regarded as severe limitations in some cases.

Instead of using one camera sensor, capturing can be done by using higher number of (i.e. more than one) camera sensors, in which case the capturing is considered to be dynamical. As described above, the used more than one camera sensors can point to the same direction or to different directions, or the used more than one camera sensors can have some overlapping shooting areas or no overlapping at all. As camera sensors are usually representing relative color differences instead of absolute colors, captures coming from multiple camera sensors suffer from color inconsistency.

Several color correction methods have already been proposed and used for improving the color consistency. One of the most common one is to use charts with known colors for various number of color targets, and then achieving a color calibration or correction by direct mapping or color relationships.

The present description discloses embodiments for a pool of a-priori captured images, wherein the pool is used in different color temperatures for a number of camera sensors. “A pool” in this description refers to a set of images that is being captured by all sensors of the multi-camera device during one iteration of a color calibration round. The images from this pool are processed in several stages to extract the color correction parameters such that the scenes captured by each camera sensors will become color consistent and according to the desired target image. For color calibration, the scene is static: it does not change in time—the content stays the same so there is no movement inside the scene and the illumination of the scene is preserved as constant as possible. If placed in same position relative to the scene, all sensors of the multi-camera device should show the same colors and the same scene content. The proposed method ensures that scene colors are the same. A robot can be used to shoot the scene from the same position by all sensors, by rotating the device accordingly.

The present embodiments work with standard existing color correction charts, e.g. also with mostly used 24 patches Macbeth color chart. In addition, the user is allowed to choose between the best color correction and the natural color correction. The natural color representation targets may show the user exactly how the scene actually was at the moment of the shooting, where only device specific characteristics have been compensated.

In the initialization stage, images for a pool of images are captured by multiple sensors and one or more of these multiple images are used in first and second stage of processing to compute the color correction factors applied to different sensors. The pool of images comprises several sets of captured images, wherein each set of captured images has been captured with different capturing parameters, e.g. different exposure times, compared to another set. One image of any of the sets of captured images can be used to measure color characteristic information or the parameters for the color transformation. Instead of having one image, also more images can be selected, and used in a same way.

Images in the pool of images contain a target color pattern, wherein the target color pattern is used for measuring color characteristics information on the captured scene. A-priori selection of the used target image pool criteria is used (e.g. scenes with a selected range of illumination). The target color pattern in the image has Red, Blue and Green target values, and all color components of the system's sensors are calibrated to this target color pattern to provide the actual color content of each scene being captured. In the embodiment, actual color alternations of known color targets and their reflection in different capturing conditions are used.

The human eye has three different types of cells (cones) with different sensitives to long (L), medium (M) and short (S) wavelengths. The response of these different types of cells form the so-called LMS color space. The human visual system adjusts according to changes in illumination to preserve the appearance of colors. This adjusting mechanism is called a chromatic adaptation or color constancy. Colors from any color space can be transformed to XYZ space. Therefore, one additional transformation matrix is enough to transform colors from XYZ to LMS color space. Since human eye has both subjective and objective characteristics, no single transformation matrix between XYZ and LMS exist. An example of transformation matrices is the Bradford transformation matrix. From spectral point of view, this transformation method sharpens L and M response curves. In order to achieve the naturalness choice for a user, a modified Bradford transformation matrix may be used in conjunction with the color correction matrices obtained at previous stages, where the color transformation is computed and selected. These changes may also be done by using new matrices for every color temperature cases provided for previous stages, such that changes occur in synchronization. As an example, in front of a burning fire face of a person looks more yellowish/red although they are e.g. white. Sensor having the color correction should produce faces looking white. On the other hand, sensor having a natural color correction should produce faces looking yellowish/red.

In the present embodiments, RGB (Red Green Blue) color model can be used for four color channels being output from Bayer out camera sensors: two greens, one red and one blue. This is an additive color model, in which red, green and blue may be added to reproduce a large variety of output colors. RGB is a device dependent color space, so a first step of using the RGB color model would be to move to a standard or device independent color space; one example is standard RGB (sRGB) color space. There are other examples of device independent color spaces as well, e.g. Adobe RGB, Apple RGB, ProPhoto color space. In a device independent color space the final target in case of multiple camera sensors is that all of the multiple camera sensors would work consistently, and one color would be the same when viewed by different camera sensors. At the same time, it is expected that the visible spectrum will be reflected in a best possible way for the majority of component colors. To compensate the differences between the spectral responses of the R, G, B components of the camera sensor and the ones of the used target color chart, a color correction matrix (CCM) is needed. The purpose of the present embodiments is to get color correction matrices for all camera sensors of the system such that the target color are reproduced in desired way—small color errors or natural. In practice this means getting a 3×3 color correction matrix (CCM) (also known as color conversion matrix). One known use of this matrix is to enforce the sum of its elements that are to be multiplied with the RGB vector to equal value one. This is not a rule, and therefore in the present embodiments the enforcing is not implemented, since the present embodiments are targeted to the naturalness of scenes. The purpose of the enforcing is to correct additionally the chromaticity flows of the human visual system: achromatic objects do not appear “naturally” or to human visual system achromatic in all illuminations. To be sure, such a “flaw” is preserved and thus the CCM sum of one is not enforced.

In the present embodiments, the desired correction of colors is achieved in one initialization stage that builds the pool of images, followed by two processing stages (Stage 1, Stage 2) of those images for resulting color calibration for the sensors:

Initialization stage: a pool of images (i.e. a set of images that is being captured by all sensors of the multi-camera device during one iteration of a color calibration round) is formed by capturing images by each camera sensor in different color temperatures and capturing conditions. Each sensor uses approximately 5-7 different exposure time values. Preferably only one exposure time would be good to use, since it is faster, but a better solution can be found in different conditions. It is appreciated that too many images increases the time spent to find a solution. The initialization stage can be automatized for one or several color patterns by using a robot to ensure that all sensors are placed correctly in face of the charts and by automatically detecting the patches forming the target color patterns. Many professional tools for color testing using known color charts rely on user to actually mark the position of the chart, so user interaction is required. By the present solution the user interaction can be avoided. The target pattern would be that each color pattern is detected as close as possible to the middle part of the frame, with mid-gray patches in center. The patches subtract the black level, and their values are re-scaled accordingly.

Stage 1: The purpose of the first stage is to find the best color transformations using the pool of images in several considered color temperatures. A color transformation is used to transform the input scene colors as seen by device in actual “real” scene colors as standardized by international color standardization boards, and finally as seen by the human eyes. As seen by human eyes is problematic, as it is strongly subjective—a represented scene by this color transformation may look good to one individual but bad to another. The transformation result deviates from standardized color values, differently for different sensors.

In the following, the input pixel values are denoted with x=[Rin Gin Bin]^{T} (T, transpose matrix) and the output pixel values are denoted with y=[Rout Gout Bout]^{T}, whereby the color correction matrix C has the form:

$$C = \begin{matrix}RinR & GinR & BinR \\ RinG & GinG & BinG \\ RinB & GinB & BinB\end{matrix}$$

where e.g. GinR means green color component present in red color spectrum inputs. Additionally, balancing of white (W) can be achieved by e.g. scaling channels such that achromaticity of one or more gray patches from the used color chart is preserved. That is denoted with:

$$W = \begin{matrix}L 2 \text{/} L 1 & 0 & 0 \\ 0 & M 2 \text{/} M 1 & 0 \\ 0 & o & S 2 \text{/} S 2\end{matrix} = \begin{matrix}{w}_{R}^{I 2} \text{/} {w}_{R}^{I 1} & 0 & 0 \\ 0 & {w}_{G}^{I 2} \text{/} {w}_{G}^{I 1} & 0 \\ 0 & 0 & {w}_{B}^{I 2} \text{/} {w}_{B}^{I 1}\end{matrix}$$

This is the diagonal model of illumination change, or the so called von Kries transform from illumination 1 (I1) to illumination 2 (I2). The matrix elements on the diagonal are the ratios of the cone responses L, M, S for the illuminant's (I1, I2) white point (w). Combining all these, it will result in color-corrected output pixel values:

y=CWx

The whole pool of the captured images (from the initialization stage) is used to extract the best color fit set of parameters (i.e. parameters defining the color transformation for one camera sensor, which color transformation gives the smallest color error relative to the color target pattern). This implemented by modifying input parameters (i.e. parameters that change how actual inputs are taken into use to achieve the solution) to achieve a wide range of color correction possibilities (i.e. to expand the returned range of solutions), wherein one of the color correction possibilities with the best desired performance (i.e. the one with smallest color error compared to the target color chart) is selected. Input channels (i.e. 4 Bayer matrix color channels mentioned above) are scaled in accordance with selected gray patches from the used target color pattern to be gray in output as well (the W matrix). CCM is initialized with the identity matrix, and then its individual elements are successively modified to reduce color errors.

When stage 1 of the color calibration has been performed alone for all camera sensors, there are issues to be solved with the achieved overall system results. For example, there may be large discrepancies among the outputs of different camera sensors for the same captured scene, although the smallest color errors were targeted. This may have been caused by the fact that the error used for selection is a global parameter, and although final error is small in value, different parts of the color spectrum are still having different contributions with different weights to the errors. In order to solve this, the color calibration process continues to stage 2.

Stage 2: The purpose of the second stage is to find the closest color transformations to the one achieved at stage 1 using the same pool of images in all considered color temperatures. In the second stage of processing, the whole pool of images is used again, and a color fit set of parameters that have the smallest errors relative to the color fit set of parameters computed in the first stage is selected for all sensors that are used to capture the images. The processing parameters (i.e. parameters that control the processing with no impact on inputs, e.g. considering the error relative to the stage 1 result) are modified to achieve the smallest range of correction possibilities, to be as close as possible to the one obtained in stage 1 (i.e. the smallest color difference). This means that input has different weights added to enforce preserving primary Red, Green and Blue, and White and Black colors. Best desired similarity is selected (i.e. the smallest color error relative to solution at Stage 1). The solution being used assumes that result is as close as possible to the new reference, the output of stage 1:

y_{STG1}=C_{STG1}Wx_{stG1}≈y_{STG2}=C_{StG2}Wx_{STG2}.

Thus, the new CCM values are estimated as:

C_{STG2}=C_{STG1}Wx_{STG1}x_{STG2}⁻¹W⁻¹

Naturalness of the scene can be achieved as a separate mode by further applying a new corrective CCM in different targeted color temperatures, similar way as the Bradford matrix. Therefore, the used CCM to achieve natural scene is modified as follows:

C_{Natural}=C_{STG2}C_{NaturalTemperatureCorrection}

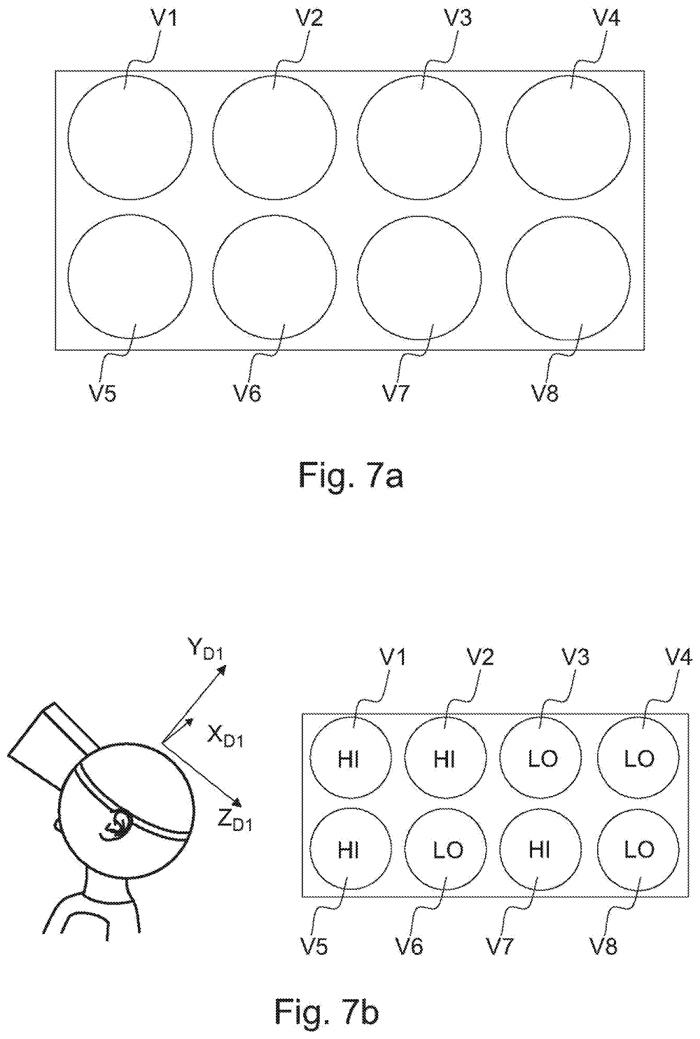

FIGS. 7a and 7b illustrate transmission of processed image data for stereo viewing. The system of stereo viewing presented in this application may employ multi-view video coding for transmitting the source video data to the viewer. That is, the server may have an encoder, or the video data may be in encoded form at the server, such that the redundancies in the video data are utilized for reduction of bandwidth. However, due to the massive distortion caused by wide-angle lenses, the coding efficiency may be reduced. In such a case, the different source signals V1-V8 may be combined to one video signal as in FIG. 7a and transmitted as one coded video stream. The viewing device may then pick the pixel values it needs for rendering the images for the left and right eyes.

The video data for the whole scene may need to be transmitted (and/or decoded at the viewer), because during playback, the viewer needs to respond immediately to the angular motion of the viewer's head and render the content from the correct angle. To be able to do this the whole 360 degree panoramic video may need to be transferred from the server to the viewing device as the user may turn his head any time. This requires a large amount of data to be transferred that consumes bandwidth and requires decoding power.

The current and predicted future viewing angles are reported back to the server with view signaling and to allow the server to adapt the encoding parameters according to the viewing angle. The server can transfer the data so that visible regions (active image sources) use more of the available bandwidth and have better quality, while using a smaller portion of the bandwidth (and lower quality) for the regions not currently visible or expected to visible shortly based on the head motion (passive image sources). In practice this would mean that when a user quickly turns their head significantly, the content would at first have worse quality but then become better as soon as the server has received the new viewing angle and adapted the stream accordingly. An advantage may be that while head movement is less, the image quality would be improved compared to the case of a static bandwidth allocation equally across the scene. This is illustrated in FIG. 7b, where active source signals V1, V2, V5 and V7 are coded with better quality than the rest of the source signals (passive image sources) V3, V4, V6 and V8.

In broadcasting cases (with multiple viewers) the server may broadcast multiple streams where each have different area of the spherical panorama heavily compressed instead of one stream where everything is equally compressed. The viewing device may then choose according to the viewing angle which stream to decode and view. This way the server does not need to know about individual viewer's viewing angle and the content can be broadcast to any number of receivers.

To save bandwidth, the image data may be processed so that part of the view is transferred in lower quality. This may be done at the server e.g. as a pre-processing step so that the computational requirements at transmission time are smaller.

In case of one-to-one connection between the viewer and the server (i.e. not broadcast) the part of the view that's transferred in lower quality is chosen so that it's not visible in the current viewing angle. The client may continuously report its viewing angle back to the server. At the same time the client can also send back other hints about the quality and bandwidth of the stream it wishes to receive.

In case of broadcasting (one-to-many connection) the server may broadcast multiple streams where different parts of the view are transferred in lower quality and the client then selects the stream it decodes and views so that the lower quality area is outside the view with its current viewing angle.

Some ways to lower the quality of a certain area of the view include for example:
Lowering the spatial resolution and/or scaling down the image data;
Lowering color coding resolution or bit depth;
Lowering the frame rate;
Increasing the compression; and/or
Dropping the additional sources for the pixel data and keeping only one source for the pixels, effectively making that region monoscopic instead of stereoscopic.

For example, some or all central camera data may be transferred with a high resolution and some or all peripheral camera data may be transferred with a low resolution. If there is not enough bandwidth to transfer all data, for example, in FIG. 6d, data from the side cameras CAM3 and CAM4 may be transferred and other data may be omitted. This allows still displaying a monoscopic image despite of the viewing direction of the viewer.

All these can be done individually, in combinations, or even all at the same time, for example per source basis by breaking the stream into two or more separate streams that are either high quality streams or low quality streams and contain one or more sources per stream.

These methods can also be applied even if all the sources are transferred in the same stream. For example a stream that contains 8 sources in an octahedral arrangement can reduce the bandwidth significantly by keeping the 4 sources intact that cover the current viewing direction completely (and more) and from the remaining 4 sources, drop 2 completely, and scale down the remaining two. In a half-mirrored-cubocahedral setting of FIG. 6d, the central cameras CAM1 and CAM2 may be sent with high resolution, CAM3 and CAM 4 with lower resolution and the rest of the cameras may be dropped. In addition, the server can update those two low quality sources only every other frame so that the compression algorithm can compress the unchanged sequential frames very tightly and also possibly set the compression's region of interest to cover only the 4 intact sources. By doing this the server manages to keep all the visible sources in high quality but significantly reduce the required bandwidth by making the invisible areas monoscopic, lower resolution, lower frame rate and more compressed. This will be visible to the user if he/she rapidly changes the viewing direction, but then the client will adapt to the new viewing angle and select the stream(s) that have the new viewing angle in high quality, or in one-to-one streaming case the server will adapt the stream to provide high quality data for the new viewing angle and lower quality for the sources that are hidden.

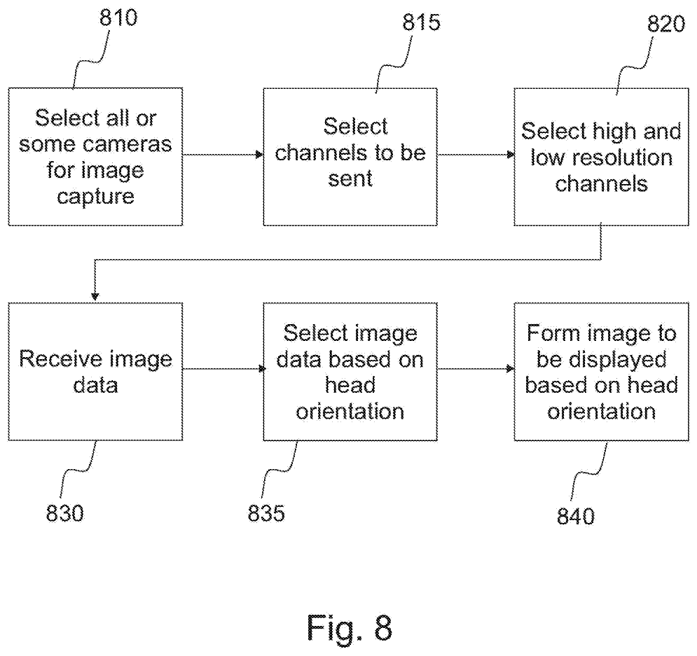

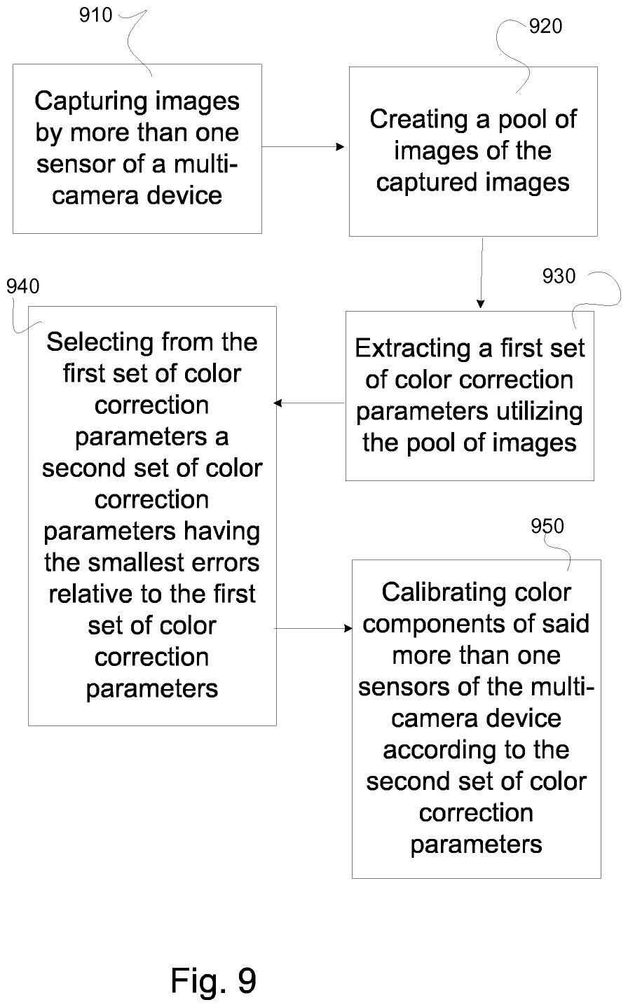

In FIG. 8, a method for viewing stereo images like stereo video is shown. In phase 810, one, two or more cameras, or all of them, are selected to capture image data such as video. The camera sensors for capturing the image data have been calibrated according to the present embodiments (see also FIG. 9). Also, the parameters and resolution of the capture may be set. For example, the central cameras may be set to capture high resolution data, and the peripheral cameras may be set to capture normal resolution data. Phase 810 may also be omitted, in which case all cameras are capturing image data.

In phase 815, the image data channels (corresponding to cameras) to be transmitted to the viewing end are selected. That is, a decision may be made not to send all the data. In phase 820, channels to be sent with high resolution and channels to be sent with low resolution may be selected. Phases 815 and/or 820 may be omitted, in which case all image data channels may be sent with their original resolution and parameters.

Phase 810 or 815 may comprise selecting such cameras of a camera device that correspond to a half sphere in the viewing direction. That is, cameras whose optical axis is in the chosen half sphere may be selected to be used. In this manner, a virtual half-sphere camera device may be programmatically constructed from e.g. a full-sphere camera device.

In phase 830, image data from the camera device is received at the viewer. In phase 835, the image data to be used in image construction may be selected. In phase 840, images for stereo viewing are then formed from the image data, as described earlier.

The various embodiments may provide advantages. For example, it is possible to use any color checker, not restricted to using a dedicated one, and allowing/presenting the user with a new way of seeing the world (the natural selection of scenes).

The various embodiments of the invention can be implemented with the help of computer program code that resides in a memory and causes the relevant apparatuses to carry out the invention. For example, a device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving and transmitting data, computer program code in a memory, and a processor that, when running the computer program code, causes the network device to carry out the features of an embodiment.

It is obvious that the present invention is not limited solely to the above-presented embodiments, but it can be modified within the scope of the appended claims.

1-12. (canceled)

13. A method, comprising:
capturing images by more than one sensor of a multi-camera device;
creating a pool of images of the captured images;
extracting a first set of color correction parameters utilizing the pool of images;
extracting a second set of color correction parameters utilizing the pool of images, wherein the second set of color correction parameters comprises the smallest error relative to the first set of color correction parameters; and
calibrating color components of said more than one sensors of the multi-camera device according to the second set of color correction parameters.

14. The method according to claim 13, wherein the images are captured in different color temperatures and different capturing conditions, and wherein the pool of images are captured in the different color temperatures and capturing conditions.

15. The method according to claim 13, further comprising detecting one or more target color patterns from the pool of images; and
defining the first set of color correction parameters to be those that give the smallest color error as compared to the color target pattern.

16. The method according to claim 13, wherein two or more of the images are captured simultaneously.

17. The method according to claim 13, wherein two or more of the images are captured at different times.

18. An apparatus comprising at least one processor, and at least one memory comprising computer program code the at least one memory and the computer program code configured to, with the at least one processor, cause the apparatus, comprising more than one sensor for capture images, to perform at least the following:
create a pool of images of captured images;
extract a first set of color correction parameters utilizing the pool of images;
extract a second set of color correction parameters utilizing the pool of images, wherein the second set of color correction parameters has the smallest error relative to the first set of color correction parameters; and
calibrate color components of said more than one sensors of the apparatus according to the second set of color correction parameters.

19. The apparatus according to claim 18, wherein images are captured in different color temperatures and capturing conditions, and wherein the pool of images comprises images in different color temperatures and capturing conditions.

20. The apparatus according to claim 18, wherein the apparatus is further caused to:
detect one or more target color patterns from the images of the pool of images; and
define the first set of color correction parameters to be those that give the smallest color error relative to the color target pattern.

21. The apparatus according to claim 18, wherein two or more of the images are captured simultaneously.

22. The apparatus according to claim 18, wherein two or more of the images are captured at different times.

23. A computer program product embodied on a non-transitory computer readable medium, comprising computer program code configured to, when executed on at least one processor, cause an apparatus or a system to:
capture images by more than one sensor of a multi-camera device;
create a pool of images of the captured images;
extract a first set of color correction parameters utilizing the pool of images;
extract a second set of color correction parameters utilizing the pool of images, wherein the second set of color correction parameters has the smallest error relative to the first set of color correction parameters; and
calibrate color components of said more than one sensors of the multi-camera device according to the second set of color correction parameters.

24. The computer program product according to claim 23, wherein the images are captured in different color temperatures and different capturing conditions, and wherein the pool of images are captured in the different color temperatures and capturing conditions.

25. The computer program product according to claim 23, further comprising detecting one or more target color patterns from the pool of images; and
defining the first set of color correction parameters to be those that give the smallest color error as compared to the color target pattern.

26. The computer program product according to claim 23, wherein two or more of the images are captured simultaneously.

27. The computer program product according to claim 23, wherein two or more of the images are captured at different times.
